(19) United States
(12) Patent Application Publication
(10) Pub. No.: US 2005/0181190 A1
(43) Pub. Date: Aug. 18, 2005

(54) Sheet made of high molecular material and method for making same

(75) Inventors: Ching-Tang Wang, Taipei (TW); Wu-Tsang Tsai, Kaohsiung (TW); Lung-Chuan Wang, Jenwu Shiang (TW); Chung-Chih Feng, Sanmin Chiu (TW); Chun-Wei Wu, Niaosong Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: San Fang Chemical Industry Co., LTD, Jenwu Shiang (TW)

(21) Appl. No.: 11/026,868

(22) Filed: Dec. 30, 2004

(30) Foreign Application Priority Data
Dec. 31, 2003 (TW) 092137682

(51) Int. Cl. B32B 3/00

(52) U.S. Cl. 428/209

(57) ABSTRACT

A method for making a macromolecular laminate is disclosed. Firstly, polyurethane resin with solid content higher than 50% is mixed with additives in order to form polyurethane resin compound that is liquid at the normal temperature. Then, the polyurethane resin compound is coated on releasing paper and dried. Then, the releasing paper is removed in order to make a substrate. Then, the substrate is put in a physical vapor deposition system in which metal is used as a target. Finally, the metal is sputtered to the substrate in order to form a metallic film, thus making a macromolecular laminate.

### BACKGROUND OF INVENTION

1. Field of Invention

The present invention relates to a macromolecular laminate and a method for making the same and, more particularly, to a macromolecular laminate with a metallic shining surface and a method for making the same.

2. Related Prior Art

In a conventional method for making a macromolecular laminate, granular, thin or powdery solid macromolecular compound (such as thermal plastic polyurethane (“TPU”), polypropylene, polyethylene and polyvinyl chloride) is mixed with additives, heated and molten. The mixture is injected, co-extruded or blow-molded to form a macromolecular substrate. Conventionally, to provide a macromolecular laminate with a metallic shining surface or feel, a transfer adhesion method is used in order to adhere a metallic film to the macromolecular substrate. However, in the macromolecular laminate with the metallic surface made through the two conventional methods, the adhesion of the metallic film to the macromolecular substrate is poor. Hence, the metallic film can easily be stripped from the macromolecular substrate. In addition, the metallic film can easily be worn and scratched.

Furthermore, because the solid macromolecular compound is used to make the macromolecular substrate in the conventional method, operative variables must be adjusted in the method for making the macromolecular substrate in order to solve problems related to melting, rheology and temperature. In a conventional method and equipment, there is a rather high minimum requirement on material. Furthermore, the complicated equipment must be cleaned up in order to make a different substrate. Therefore, it is material-intensive, time-consuming and expensive. In the conventional method for making the substrate, the hardness of the macromolecular resin such as TPU is about 85 to 98 (scale: Shore Hardness, A; test method: ASTM D-2240), and the 100% modulus is about 60 to 130 kg/cm² (test method: ASTM D-412). The substrate is hard, not soft. According to the conventional method and material, the laminate is made with only limited patterns and colors. Generally, in the conventional method for using the solid macromolecular compound to make the macromolecular substrate, lubricant or plasticizer is used. The lubricant or plasticizer is however released from the surface of the substrate so that the metallic film loses its brightness.

### SUMMARY OF INVENTION

The primary objective of the present invention is to provide a method for making a macromolecular laminate that can obviate or at least alleviate the problems encountered in prior art.

To achieve the above-mentioned objective and other objectives, the present invention provides a method for making a macromolecular laminate. Firstly, first type of polyurethane resin compound is coated on releasing paper in order to make a main layer. The first type of polyurethane resin compound is made of polyurethane resin with solid content higher than 50% and is liquid at the normal temperature. Then, the releasing paper is removed from the main layer, thus leaving a macromolecular laminate.

Furthermore, before the first polyurethane resin compound is coated, a second type of polyurethane resin compound may be coated on the releasing paper in order to form an auxiliary layer. Then, the first type of polyurethane resin compound is coated on the auxiliary layer. The second type of polyurethane resin compound is made of polyurethane resin with solid content lower than 50%. Thus, the auxiliary layer is thinner than the main layer. The auxiliary layer can be made with a different color than the main layer so that the substrate exhibits a desired color. In addition, the releasing paper may include a pattern in order to leave a pattern on the substrate.

After the substrate is made, it is put in a physical vapor deposition system in which metal is used as a target. Then, the metal is sputtered to the substrate in order to form a metallic film, thus making a macromolecular laminate. Moreover, laser may be used to form patterns or words on the metallic film.

The present invention is characterized in using high solid-content polyurethane resin compound that is liquid at the normal temperature (the first type of polyurethane resin compound) to form the thick macromolecular substrate. Because no solid macromolecular compound is used, there is no need to control complicated variables in order to solve problems related to the melting, rheology and temperature of such solid macromolecular compound. In addition, a blender and a coating device can be used instead of a conventional bulky and complicated machine. Hence, the substrate can be made at a small or large number based on the need. Furthermore, only the blender and the coating device have to be cleaned between two different batches of substrates. Hence, the material, time and cost are reduced significantly. Moreover, in the macromolecular laminate, the adhesion of the metallic film to the substrate is excellent. Hence, the metallic film exhibits good resistance against wearing and scratching. The laminate is flexible since it is made of polyurethane resin in the present invention. In addition, since no lubricant is used, the brightness of the metallic film lasts for long.

Other advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1a is a cross-sectional view of a laminate at a step of a method according to the present invention, and shows an auxiliary layer formed on releasing paper.

FIG. 1b is a cross-sectional view of the laminate at another step of the method according to the present invention, and shows a main layer formed on the auxiliary layer.

FIG. 1c is a cross-sectional view of the laminate at another step of the method according to the present invention, and shows the releasing paper removed in order to form a macromolecular substrate.

FIG. 1d is a cross-sectional view of the laminate at another step of the method according to the present invention, and shows a metallic film formed on the macromolecular substrate.

FIG. 2 is a simplified scheme of a physical vapor deposition device used in the method according to the present invention.

### DETAILED DESCRIPTION OF EMBODIMENTS

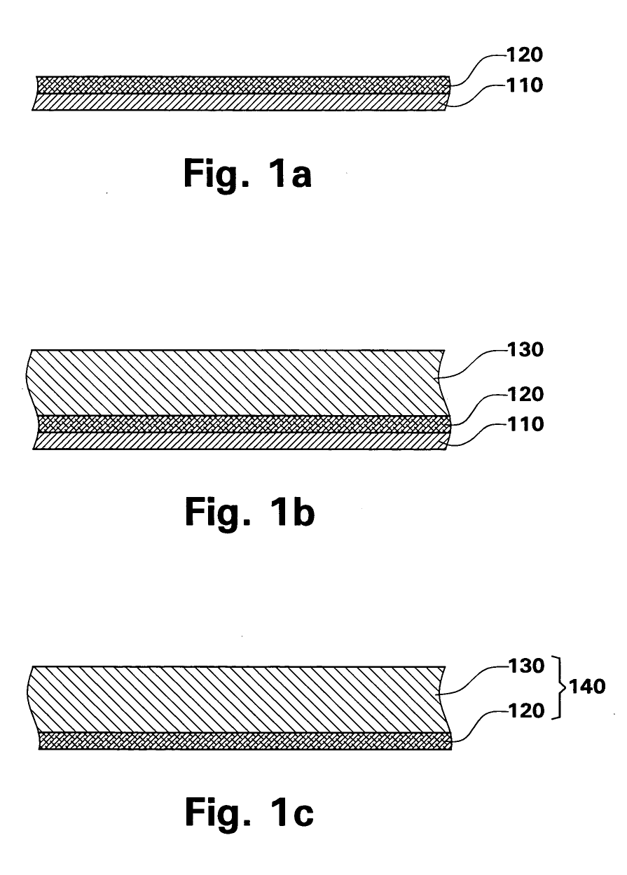

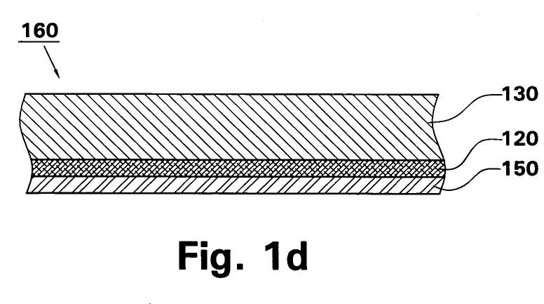

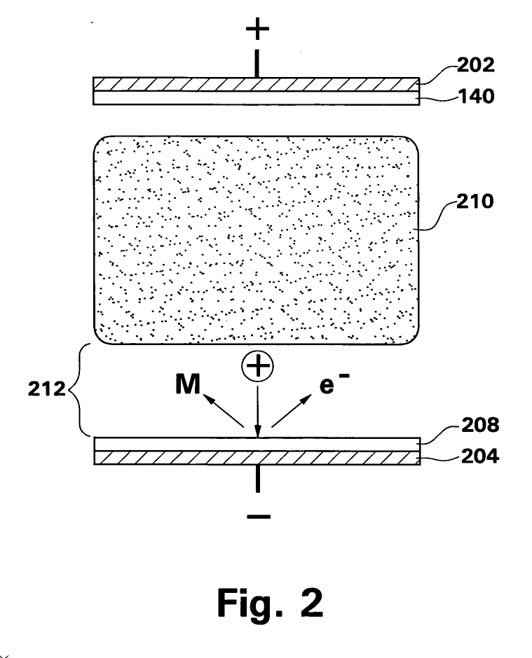

Referring to FIGS. 1a through 1d, a method for making a macromolecular laminate will be described. Firstly, referring to FIG. 1a, polyurethane resin is coated on releasing paper 110 and dried in order to form an auxiliary layer 120. Then, referring to FIG. 1b, high solid-content polyurethane resin is coated on the auxiliary layer 120 and dried and cured in order to form a main layer 130. Then, referring to FIG. 1c, the releasing paper 110 is removed in order to form a macromolecular substrate 140 with thickness of 0.01 to 3 mm. Finally, referring to FIG. 2, the substrate 140 is in a physical vapor deposition device 200 in which metal is used as a target. Then, by means of sputtering, the metal is coated on the substrate 140 (preferably the auxiliary layer 120) in order to form a metallic film 150. Thus, a macromolecular laminate 160 (see FIG. 1d) is made. Furthermore, laser may be used to form patterns or words on the metallic film 150.

The metallic film 150 is formed by means of physical vapor deposition. Physical vapor deposition is namely film deposition through a physical process without involving any chemical process. A physical process is about exchanges of phases of material, e.g., a vapor deposition source is transformed into plasma with partially ionized gas from gas. A voltage is provided to two electrodes. If the concentration of the gas molecules between the electrodes, secondary electrons caused by ion bombardment near the electrodes will obtain enough energy in the electric field caused by the electrode. Referring to FIG. 2, a cathode 204 is subject to ion bombard. From a plasma region 210, ions with positive charges obtain a lot of energy as they accelerate in the electric field in the dark region 212. As the ions bomb the cathode 204, the ions not only produce secondary electrons knock atoms from the target material 208 connected with the cathode 204 because of momentum transfer. This is called sputtering. The atoms that are knocked from the target material 208 enter the plasma and travel, through diffusion for example, to and finally deposit on the substrate 140.

A feature of the present invention is using the high solid-content liquid polyurethane resin to form the rather thick main layer 130 (the thickness of the main layer 130 may reach 3 mm) in order to provide the thick and elastic substrate 140. The solid content of the polyurethane resin for making the main layer 130 is higher than 50% and, more preferably, 80% to 100% and, more preferably, 99%. More specifically, the high solid-content polyurethane resin contains a relative small amount of organic dissolvent and does not release a large amount of organic dissolvent when forming the main layer 130. The thickness of the high solid-content polyurethane resin only changes a little before and after it is dried so that the polyurethane resin can easily form the thick main layer 130 that is thick and flexible. Furthermore, for many purposes, one or more additives, such as filler, auxiliary, crosslinker and colorant may be added to the high solid-content polyurethane resin. Preferably, the filler should be less than 50% of the high solid-content polyurethane resin. The filler should be less than 20% of the high solid-content polyurethane resin. The crosslinker should be less than 20% of the high solid-content polyurethane resin. The colorant should be less than 15% of the high solid-content polyurethane resin. In the embodiment of the present invention, preferably, the high solid-content polyurethane resin is baked at about 100 to 170 degrees Celsius. Moreover, foaming agent may be added to the high solid-content polyurethane resin in order to form a porous main layer 130.

Another feature of the present invention is using the low solid-content polyurethane resin to form the auxiliary layer 120 on the main layer 130. The solid content of the polyurethane resin for making the auxiliary layer 120 is lower than 50% and, more preferably, 10% to 30%. For being made of the low solid-content polyurethane resin, the auxiliary layer 120 is thinner than the main layer 130. The auxiliary layer 120 may exhibit a different color than the main layer 130 so that the substrate 140 exhibits a desired color. Based on design requirements, the auxiliary layer 120 may be made to include a plurality of layers with a same color or different colors. Furthermore, the releasing paper 110 may include a pattern in order to leave a pattern on the substrate 140 after it is removed.

The present invention is characterized in using the high solid-content polyurethane resin compound to form the thick macromolecular substrate 140. Because no solid macromolecular compound is used, there is no need to control complicated variables in order to solve problems related to the melting, rheology and temperature of such solid macromolecular compound. In addition, a blender and a coating device can be used instead of a conventional bulky and complicated machine. Hence, the substrate 140 can be made at a small or large number based on the need. Furthermore, only the blender and the coating device have to be cleaned between two different batches of substrates 140. Hence, the material, time and cost are reduced significantly. Moreover, in the macromolecular laminate 160, the adhesion of the metallic film 150 to the substrate 140 is excellent. Hence, the metallic film 150 exhibits good resistance against wearing and scratching. The laminate 160 is flexible since it is made of polyurethane resin in the present invention. In addition, because no lubricant is used, the brightness of the metallic film 150 lasts for long. The macromolecular laminate of the present invention may be used as a logo or a surface layer adhered to ordinary leather.

The following embodiment is given in order to describe, not to limit, the present invention in detail:

100 PHR of polyurethane resin with solid content of 99%, 20 PHR of filler, 3 PHR of modifier and 5 PHR of crosslinker are mixed to form high solid-content polyurethane resin coating. PHR (“parts per hundred parts of resin by mass”) means an amount of units of mass of additive added to 100 units of mass of the polyurethane resin.

After coated on releasing paper, the polyurethane resin is dried at 165 degrees Celsius in order to form a substrate. Then, the releasing paper is removed, thus leaving a thick and flexible substrate.

Then, the substrate is put in a sputtering device. At 10-4 to 10-5 torr, Ar ions bomb a copper target in order to form a copper film on the substrate so as to make a macromolecular laminate with a metallic shining surface.

The present invention has been described via detailed illustration of some embodiments. Those skilled in the art can derive variations from the embodiments without departing from the scope of the present invention. Therefore, the embodiments shall not limit the scope of the present invention defined in the claims.

1. A method for making a macromolecular laminate comprising the steps of:
mixing polyurethane resin with solid content higher than 50% with additives in order to form a first type of polyurethane resin compound that is liquid at the normal temperature;
coating the first type of polyurethane resin compound on releasing paper;
drying the first type of polyurethane resin compound in order to form a main layer;
removing the releasing paper from the main layer in order to make a substrate;
putting the substrate in a physical vapor deposition system in which metal is used as a target; and
sputtering the metal to the substrate in order to form a metallic film, thus making a macromolecular laminate.

2. The method for making a macromolecular laminate according to claim 1 wherein the first type of polyurethane resin compound is made of polyurethane resin with solid content of 80% to 100%.

3. The method for making a macromolecular laminate according to claim 1 wherein the step of drying is conducted at 110 to 170 degrees Celsius.

4. The method for making a macromolecular laminate according to claim 1 further comprising the step of coating a second type of polyurethane resin compound on the releasing paper, the step of drying the second type of polyurethane resin compound in order to make an auxiliary layer and the step of coating the first type of polyurethane resin compound on the auxiliary layer.

5. The method for making a macromolecular laminate according to claim 4 wherein the second type of polyurethane resin compound is made of polyurethane resin with solid content lower than 50%.

6. The method for making a macromolecular laminate according to claim 4 wherein the auxiliary layer is made with a different color than the main layer.

7. The method for making a macromolecular laminate according to claim 4 wherein the auxiliary layer is thinner than the main layer.

8. The method for making a macromolecular laminate according to claim 4 wherein the metallic film is coated on the auxiliary layer.

9. The method for making a macromolecular laminate according to claim 1 wherein the thickness of the macromolecular laminate is 0.01 to 3 mm.

10. The method for making a macromolecular laminate according to claim 1 wherein the releasing includes a pattern in order to leave at least a pattern on the macromolecular laminate.

11. The method for making a macromolecular laminate according to claim 1 further comprising the step of providing laser on the metallic film in order to form at least one of patterns and words.

12. A macromolecular laminate comprising:
a main layer made of a first type of polyurethane resin compound that is liquid at the normal temperature, the first type of polyurethane resin compound is made through mixing polyurethane resin with solid content higher than 50% with additives; and
a metallic film formed on the main layer.

13. The macromolecular laminate according to claim 12 wherein the metallic film comprises at least one of patterns and words.

14. The macromolecular laminate according to claim 12 further comprising an auxiliary layer between the main layer and the metallic film, wherein the auxiliary layer is made of a second type of polyurethane resin compound.

15. The macromolecular laminate according to claim 14 wherein the second type of polyurethane resin compound is made of polyurethane resin with solid content lower than 50%.

16. The macromolecular laminate according to claim 14 wherein the auxiliary layer is made with a different color than the main layer.

17. The macromolecular laminate according to claim 14 wherein the auxiliary layer is thinner than the main layer.

18. The macromolecular laminate according to claim 12 wherein the thickness of the macromolecular laminate is 0.01 to 3 mm.

19. The macromolecular laminate according to claim 12 wherein the macromolecular laminate comprises a pattern.

20. The macromolecular laminate according to claim 16 wherein the auxiliary layer is a laminate of layers with different colors.
